(19) United States
(12) Patent Application Publication
(10) Pub. No.: US 2023/0027546 A1
(43) Pub. Date: Jan. 26, 2023

(54) METHOD AND DEVICE FOR GENERATING ELECTRIC CURRENT, AND USE OF AN ORGANIC COMPOUND FOR GENERATING ELECTRIC CURRENT

(71) Applicant: HYDROGENIOUS LOHC TECHNOLOGIES GMBH, Erlangen (DE)

(72) Inventors: Peter WASSERSCHEID, Erlangen (DE); Karsten MÜLLER, Rostock (DE); Simon THIELE, Erlangen (DE)

(21) Appl. No.: 17/782,413

(22) PCT Filed: Nov. 24, 2020
(86) PCT No.: PCT/EP2020/083240

§ 371 Date: Jun. 3, 2022

(30) Foreign Application Priority Data
Dec. 4, 2019 (DE) 10 2019 218 907.5

(51) Int. Cl. H01M 8/0612; H01M 8/04291; H01M 8/1004

(52) U.S. Cl. CPC H01M 8/0631; H01M 8/04291; H01M 8/1004; H01M 2250/20

(57) ABSTRACT

A method for generating electric current comprises the method steps of providing an organic compound having at least one ether function, reacting the organic compound with water in a reaction chamber having an acidic environment to form an enriched hydrogen carrier medium, converting the enriched hydrogen carrier medium into electricity to form a depleted hydrogen carrier medium in a fuel cell, obtaining water, and providing electric current generated during said conversion into electricity.

### CROSS-REFERENCES TO RELATED APPLICATIONS

This application claims the priority of German Patent Application, Serial No. DE 10 2019 218 907.5, filed Dec. 4, 2019, the content of which is incorporated herein by reference in its entirety as if fully set forth herein.

### FIELD OF THE INVENTION

The invention relates to a method and device for generating electric current and to the use of an organic compound for generating electric current.

### BACKGROUND OF THE INVENTION

Electrical energy is required to operate electrical devices, in particular electric motor-driven mobile platforms such as vehicles and/or aircrafts, but also for decentralized and/or non-stationary applications. In order to provide the electrical energy required for operation, electrical storage units in the form of batteries are used, especially for mobile applications. Batteries have a high weight which has to be moved along with the mobile application. This increases the energy consumption for the mobile application. Electrical storage units are essentially dispensable or significantly reduced in size if electrical energy is provided by operating a fuel cell.

### SUMMARY OF THE INVENTION

It is an object of the invention to improve the provision of electrical energy, in particular for mobile applications, wherein in particular the efficiency in power generation is increased.

This object is achieved according to the invention by a method for generating electric current, comprising the method steps of providing an organic compound having at least one ether function, reacting the organic compound with water in a reaction chamber having an acidic environment to form an enriched hydrogen carrier medium, converting the enriched hydrogen carrier medium into electricity to form a depleted hydrogen carrier medium in a fuel cell, obtaining water, and providing electric current generated during said conversion into electricity, by a device for generating electric current, comprising a reaction chamber having an acidic milieu in which an organic compound can be reacted with water to form an enriched hydrogen carrier medium, a fuel cell having an anode compartment, a proton-conducting membrane, and a cathode compartment for converting the enriched hydrogen carrier medium into electricity to form a depleted hydrogen carrier medium, wherein the reaction chamber is connected to the anode compartment for delivering the enriched hydrogen carrier medium and by a use of an organic compound for generating electric current, wherein the organic compound has at least one ether function.

The essence of the invention is that an organic compound having an ether function is reacted with water in an acidic environment to form an enriched hydrogen carrier medium, which is converted into electricity to form a depleted hydrogen carrier medium in a fuel cell, obtaining water. The electric current generated during the conversion into electricity can be used directly, in particular in a mobile application. The organic compound is in particular a hydrocarbon compound and may have, in addition to the ether function, at least one double bond and/or at least one triple bond. The organic compound may also have multiple double bonds and/or multiple triple bonds and/or multiple ether functions. The reaction of the organic compound is carried out in particular by cleavage of the ether function. The reaction of the organic compound with water in an acidic environment leads to the formation of an enriched hydrogen carrier medium, which in particular contains one or more secondary alcohol functions, resulting in an increased hydrogen storage density and thus in an increased volumetric efficiency of the provision of electric current.

The hydrocarbon compound is in particular a diisoalkyl ether. In particular, the hydrocarbon compound is diisopropyl ether. In particular, the organic compound is free of homoaromatic groups, such as phenyl, benzyl and/or naphthyl groups. In particular, the organic compound is 2,5-dimethylfuran or a furan derivative that can be cleaved with water to form an organic molecule having multiple secondary alcohol functions. In particular, the organic compound is liquid.

A key finding of the invention is based on the fact that by converting the organic compound into the enriched hydrogen carrier medium, a fuel with increased hydrogen capacity can be provided. The efficiency in the generation of electric current is thereby improved. The range of a mobile application, in particular a vehicle or an aircraft, is increased.

The acidic environment in which the organic compound is converted into the enriched hydrogen carrier medium has a pH value of less than 3, preferably less than 2. The pH value is obtained in particular by the presence in the reaction compartment of a mineral acid, such as sulfuric acid, an organic acid, such as methanesulfonic acid, trifluoromethanesulfonic acid or toluenesulfonic acid, or a solid acid, such as an acidic ion exchange resin, an acidic metal oxide, in particular a zeolite, an acidic supported ionic liquid, a supported mineral acid and/or a supported organic acid or a fluorinated polymer containing acidic sulfonic acid groups.

The enriched hydrogen carrier medium has in particular at least one secondary alcohol group and in particular only a very small proportion of primary alcohol groups of less than 1% of the enriched hydrogen carrier medium. The enriched hydrogen carrier medium is in particular an isoalcohol compound, in particular isopropanol. The enriched hydrogen carrier medium is liquid, in particular at room temperature.

The depleted hydrogen carrier medium is in particular a ketone, in particular acetone, 2-butanone, diacyl or a pentanedione and is in particular liquid at room temperature. It is particularly advantageous that the depleted hydrogen carrier medium, in particular at a place and/or time where hydrogen is readily available, can first be converted by catalytic hydrogenation into an enriched hydrogen carrier medium and by subsequent catalytic dehydrogenation back to the organic compound having at least one double bond and/or at least one triple bond which is provided for the method according to the invention. This creates a closed cycle that enables energy storage in the form of hydrogen and energy transport in the form of hydrogen by means of an organic liquid. Electrical energy can be provided as needed.

According to the invention, it has also been found that for the generation of electric current from the organic compounds according to the invention, no or at most a small amount of CO₂ emissions are caused. Thus, the method according to the invention differs from the conversion of primary alcohols into electricity known in the prior art, such as the conversion of methanol into electricity in a direct methanol fuel cell, in which complete decomposition of the alcohol into water and CO₂ occurs, i.e., one mole of CO₂ is formed per mole of methanol converted into electricity. In contrast, when the enriched hydrogen carrier medium according to the invention is converted into electricity, a maximum of 0.05 mol of CO₂ is formed per mol of hydrogen carrier medium converted into electricity.

Another advantage over the conversion of primary alcohols into electricity is the avoidance of carbon monoxide (CO), which acts in particular as a catalyst poison and therefore leads to a low open-circuit voltage and low efficiency of the conversion into electricity.

One advantage of the invention is that the water produced during the conversion of the hydrogen carrier medium into electricity can be used directly for the reaction of the organic compound to produce the enriched hydrogen carrier medium. Water required for the reaction of the organic compound, i.e. for the hydrogenation of the organic compound, therefore does not have to be stored in the organic compound itself. This results in an increase in the usable energy density; a higher amount of energy can be generated per mass of organic compound. The oxygen in the water, which is generated in the fuel cell as a co-product, comes in particular from the air. Therefore, in the inventive method, oxygen from the air is used to generate the enriched hydrogen carrier medium from the organic compound used for the conversion into electricity in the fuel cell.

The method according to the invention consisting of hydrogenation of the organic compound to form the enriched hydrogen carrier medium and the conversion of the enriched hydrogen carrier medium into electricity on the anode catalyst is carried out in particular at a temperature between 0° C. and 300° C., in particular between 25° C. and 250° C. and in particular between 40° C. and 180° C.

The two steps can be carried out in one reaction compartment or in separate, preferably adjacent reaction chambers. The temperatures of the two steps may be the same or different. Preferably, the temperature of the conversion into electricity is equal to or higher than the temperature of the hydrogenation. The mixing ratio of water to the organic compound is between 0.5 and 10, in particular between 1 and 5 and in particular between 1 and 2.

A method in which the water from the fuel cell generated during the conversion into electricity is returned at least proportionally, in particular completely, to the reaction chamber for the reaction of the organic compound has an increased efficiency in usable energy density. In particular, the water generated in the fuel cell, in particular in the cathode compartment of the fuel cell, is returned to the reaction compartment in which hydrogenation of the organic compound is carried out to form the enriched hydrogen carrier medium. In particular, all of the water formed in the fuel cell is returned to the reaction compartment. It is conceivable to selectively discharge excess water from the fuel cell and/or to store it temporarily in a storage container provided for this purpose. In this case, water from the intermediate storage container, which has previously been fed from the fuel cell, can be supplied to the reaction compartment. It is particularly advantageous if at least a certain proportion of water is to be made available independently for starting the fuel cell.

A method in which the hydrogen capacity of the organic compound is greater than the hydrogen capacity of the enriched hydrogen carrier medium, wherein the hydrogen capacity of the organic compound is at least 1.05 times, in particular 1.1 times, in particular 1.12 times, in particular 1.15 times and in particular 1.19 times the hydrogen capacity of the enriched hydrogen carrier medium has an increased hydrogen capacity. Hydrogen capacity is understood to mean the usable hydrogen molecule mass. In particular, a hydrogen capacity can be realized for the organic compound which is greater than the hydrogen capacity of the enriched hydrogen carrier medium.

A method using at least one organic compound, wherein the organic compound is in particular diisoalkyl ether, in particular diisopropyl ether, diisobutyl ether, diisopentyl ether, 2,5-dimethylfuran, 2,6-dimethylpyran, mono-isopropyl ether of secondary alcohols, of secondary diols, of secondary triols and/or of carbohydrate compounds having exclusively secondary alcohol functions, di-isopropyl ethers of secondary diols, of secondary triols and/or of carbohydrate compounds having exclusively secondary alcohol functions, tri-isopropyl ethers of secondary triols and/or of carbohydrate compounds having exclusively secondary alcohol functions, oligo-isobutyl ethers having more than three isopropyl groups of carbohydrate compounds having exclusively secondary alcohol functions, mono-isobutyl ethers of secondary alcohols, of secondary diols, of secondary triols and/or of carbohydrate compounds having exclusively secondary alcohol functions, di-isobutyl ethers of secondary diols, secondary triols and/or of carbohydrate compounds having exclusively secondary alcohol functions, tri-isobutyl ethers of secondary triols and/or of carbohydrate compounds having exclusively secondary alcohol functions, olio-isobutyl ethers having more than three isopropyl groups of carbohydrate compounds having exclusively secondary alcohol functions, cyclic ethers having one or more oxygen atoms, during the hydrolytic cleavage of which exclusively secondary alcohol functions are formed, or a mixture of at least two of the above-mentioned compounds, has proven to be particularly advantageous, in particular with respect to efficiency in power generation.

A method in which a membrane of the fuel cell and/or a separate acidic catalyst serves as acidic medium for generating the acidic environment required for the reaction of the organic compound ensures the acidic environment required for the reaction of the organic compound in a particularly uncomplicated manner. For example, a membrane of the fuel cell may have a membrane material suitable for generating the acidic environment in the fuel cell, in particular in the anode compartment of the fuel cell. In this case, the reaction compartment for reacting the organic compound is integrated in the fuel cell. In particular, the membrane material is a persulfonic acid material such as a fluorinated or perfluorinated polymer which contains a sulfonic acid group as an ionic group. The fluorinated or perfluorinated polymer may also serve as an ionomer. Suitable polymers are sold under the brand names “Nafion” or “Aquivion”.

Surprisingly, it has been found that the membrane of a PEM fuel cell has a higher stability towards the organic compound compared to secondary alcohols. Liquid secondary alcohols in pure form dissolve the ionomer layers of the PEM membrane very efficiently, in particular in the presence of water and the product ketone, which may impair and especially destroy the function of the fuel cell. In contrast, the organic compounds according to the invention, in particular diisoalkyl ethers as well as cyclic ethers, have no or only very low solubility for the ionomer layer of the PEM membrane, even with product ketone and water. The service life of the fuel cell is increased, in particular also when the ionomer layer of the fuel cell is brought into contact with the organic compound and/or the enriched hydrogen carrier medium and/or the depleted hydrogen carrier medium for a longer period of time at elevated temperatures.

Alternatively or additionally, a separate acidic catalyst can be used which acts as a Brønsted acid. Preferably, a mineral acid, such as sulfuric acid, an organic acid, such as methanesulfonic acid, trifluoromethanesulfonic acid or toluenesulfonic acid, or a solid acid, such as an acidic ion exchange resin, an acidic metal oxide, in particular a zeolite, an acidic supported ionic liquid, a supported mineral acid and/or a supported organic acid or a fluorinated polymer having acidic sulfonic acid groups is used as catalyst.

The method enables efficient implementation in a compact device. In particular, a reaction chamber in which the reaction of the organic compound takes place is integrated in the anode compartment of the fuel cell. Alternatively, the reaction chamber is connected to the anode compartment via a fluid line. In particular, the reaction chamber in this case is designed separately from the anode compartment, i.e. spatially separated from the anode compartment. In particular, however, the reaction chamber is arranged in close spatial proximity to the anode compartment. In particular, the reaction chamber is arranged adjacent to the anode compartment, in particular in a common assembly, which may in particular have a common housing in which the reaction chamber and the fuel cell are arranged.

A method in which the organic compound is provided by dehydrogenation of a precursor enables an additional conversion into electricity, in particular of hydrogen gas (H₂). This additionally increases the efficiency of power generation. A dual use results from a double conversion into electricity. In particular, the hydrogen gas released during the dehydrogenation of a precursor can be used in an additionally provided second fuel cell, in particular a hydrogen fuel cell. The second fuel cell may be of an uncomplicated design. The second fuel cell may be connected to the reaction chamber along a return line, in particular with an intermediate storage container. The hydrogen gas can also be converted into electricity in the fuel cell provided anyway. In this case, a second fuel cell is unnecessary.

In particular, 2,5-dimethyltetrahydrofuran and/or 2,6-dimethyltetrahydropyran serves as a precursor. In particular, the precursor is an organic compound which can be converted by dehydrogenation into an organic compound having one or more ether functions and, in particular, additionally having one or more double bonds and/or having one or more triple bonds.

A device for generating electric current, comprising a reaction chamber having an acidic milieu in which an organic compound can be reacted with water to form an enriched hydrogen carrier medium, a fuel cell having an anode compartment, a proton-conducting membrane, and a cathode compartment for converting the enriched hydrogen carrier medium into electricity to form a depleted hydrogen carrier medium, wherein the reaction chamber is connected to the anode compartment for delivering the enriched hydrogen carrier medium substantially has the advantages of the method according to the invention, reference being hereby made thereto. The device according to the invention enables small-scale, weight-efficient generation of electric current. It is essential that the reaction chamber in which the organic compound is reacted with water to form the enriched hydrogen carrier medium has an acidic milieu, which enables an acidic environment for the reaction of the organic compound. It is also essential that the anode compartment of the fuel cell is connected to the reaction chamber. In particular, the reaction chamber is directly connected to the anode compartment. As a result, the delivery of the enriched hydrogen carrier medium from the reaction chamber to the anode compartment is efficient and uncomplicated. The generation of electric current is possible by the device in a fail-safe and functionally integrated manner.

The fuel cell used is in particular a polymer electrolyte membrane (PEM) fuel cell, which is operated in particular at a temperature of below 350° C.

A device configured such that the reaction chamber is integrated in the anode compartment of the fuel cell, wherein in particular the proton-conducting membrane has a material that generates the acidic milieu is of small design. Due to the fact that the reaction chamber is integrated in the anode compartment of the fuel cell, no additional installation space is required.

A device configured such that the reaction chamber is connected to the anode compartment via a fluid line, wherein in particular in the reaction chamber an acidic catalyst is provided is particularly uncomplicated to retrofit by connecting an existing fuel cell to a reaction chamber connected to the anode compartment of the fuel cell via a fluid line.

A device configured such that the cathode compartment is connected to the reaction chamber via a return line for the return of water ensures a reliable return of water formed in the cathode compartment of the fuel cell into the reaction chamber. In addition, a storage container for water can be provided, in particular along the return line, in order to store water and, in particular, to make it available in the reaction chamber for starting the fuel cell.

A device comprising a second fuel cell for the conversion into electricity of hydrogen gas which is produced in particular during a dehydrogenation of a precursor in a dehydrogenation reactor to from the organic compound enables a direct and uncomplicated conversion of hydrogen gas, which is produced in particular during a dehydrogenation of a precursor, into electricity. The efficiency in the generation of the electric current is increased.

The use of an organic compound for generating electric current, wherein the organic compound has at least one ether function, is based on the finding that an organic compound known per se can be advantageously used as a fuel in a fuel cell for generating electric current. The organic compound is an organic fuel. In particular, it has been recognized that for the use of the organic compound as an organic fuel in a fuel cell, it is possible to use oxygen from the environment, in particular from the ambient air, in the conversion into electricity. The entrainment of oxygen is dispensable and enables a particularly light-weight realization of the conversion of the organic compound into electricity. It has further been recognized that the water generated during the conversion into electricity can be used directly for a conversion reaction of the organic compound. The reaction of the organic compound makes the conversion into electricity particularly efficient. The organic compound has a particularly high hydrogen storage density. The organic compound is in particular a hydrocarbon compound.

The use wherein the generation of current takes place in a mobile application, in particular in a vehicle or in an aircraft is particularly suitable for mobile application.

An organic compound wherein the organic compound is in particular diisopropyl ether, diisobutyl ether, diisopentyl ether, 2,5-dimethylfuran, 2,6-dimethylpyran, mono-isopropyl ether of secondary alcohols, of secondary diols, of secondary triols and/or of carbohydrate compounds having exclusively secondary alcohol functions, di-isopropyl ether of secondary diols, of secondary triols and/or of carbohydrate compounds having exclusively secondary alcohol functions, tri-isopropyl ethers of secondary triols and/or of carbohydrate compounds having exclusively secondary alcohol functions, oligo-isobutyl ethers having more than three isopropyl groups of carbohydrate compounds having exclusively secondary alcohol functions, mono-isobutyl ethers of secondary alcohols, of secondary diols, of secondary triols and/or of carbohydrate compounds having exclusively secondary alcohol functions, di-isobutyl ethers of secondary diols, secondary triols and/or of carbohydrate compounds having exclusively secondary alcohol functions, tri-isobutyl ethers of secondary triols and/or of carbohydrate compounds having exclusively secondary alcohol functions, olio-isobutyl ethers having more than three isopropyl groups of carbohydrate compounds having exclusively secondary alcohol functions, cyclic ethers having one or more oxygen atoms, during the hydrolytic cleavage of which exclusively secondary alcohol functions are formed, or a mixture of at least two of the above-mentioned compounds, has proven to be particularly advantageous for use as an organic fuel.

Both the features indicated in the patent claims and the features indicated in the following embodiments of a device according to the invention are each suitable, either on their own or in combination with one another, for further developing the object according to the invention. The respective combinations of features do not represent any restriction with regard to the further embodiments of the subject matter of the invention, but are essentially merely exemplary in character.

Further features, advantages and details of the invention will be apparent from the following description of four embodiments based on the drawing.

### BRIEF DESCRIPTION OF THE DRAWING

FIG. 1 shows a schematic illustration of a device according to the invention with diisopropyl ether cleavage in the anode compartment of a fuel cell,

FIG. 2 shows an illustration corresponding to FIG. 1 of a device according to a second embodiment with the diisopropyl ether cleavage in a separate reaction chamber,

FIG. 3 shows an illustration corresponding to FIG. 1 of a device according to a third embodiment with dehydrogenation upstream of the ether cleavage, 20

FIG. 4 shows an illustration corresponding to FIG. 2 of a device according to a fourth embodiment with dehydrogenation upstream of the ether cleavage in a separate reaction chamber.

### DESCRIPTION OF THE PREFERRED EMBODIMENTS

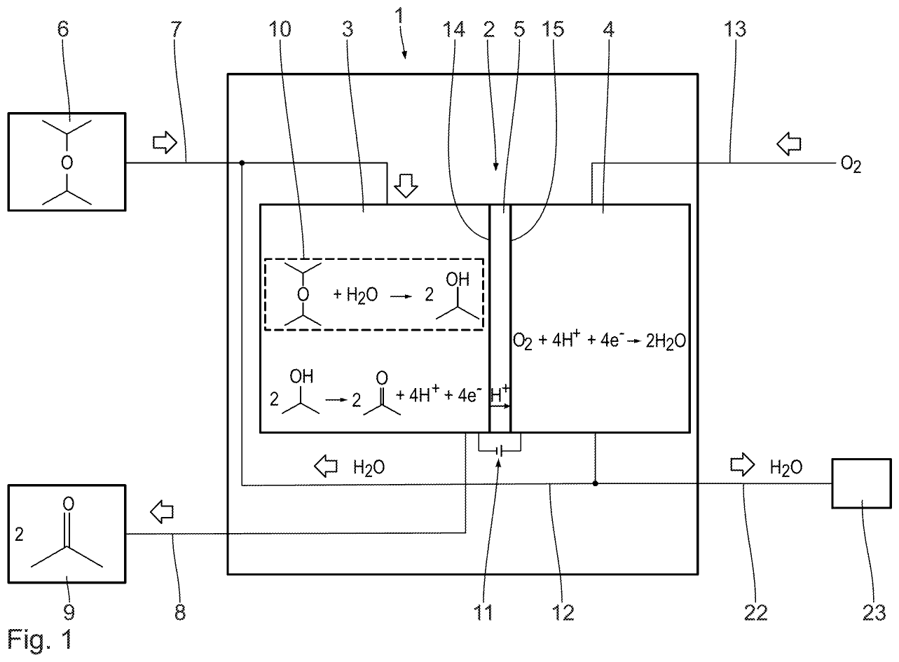

A device marked 1 as a whole in FIG. 1 comprises a fuel cell 2, which is designed as a PEM fuel cell. The fuel cell 2 comprises an anode compartment 3 and a cathode compartment 4, which is separated from the anode compartment 3 by a proton-conducting membrane 5.

A first storage container 6 is connected to the anode compartment 3 via a feed line 7. An organic compound is stored in the first storage container 6. According to the embodiment shown, diisopropyl ether is used as the organic compound.

A second storage container 9 is connected to the anode compartment 3 via a discharge line 8. Depleted hydrogen carrier medium is stored in the second storage container 9. According to the embodiment shown, acetone is the depleted hydrogen carrier medium.

A reaction chamber 10 is integrated in the anode compartment 3 of the fuel cell 2. The reaction chamber 10 corresponds to a reaction compartment. The reaction compartment is not spatially separated from the anode compartment 3. In particular, the reaction chamber 10 is identical to the anode compartment 3. The reaction chamber 10 is indicated by a dashed line in FIG. 1. The reaction chamber 10 is directly connected to the anode compartment 3. Due to the fact that the PEM membrane 5 is directly connected to the anode compartment 3, the anode compartment 3, in particular the reaction chamber 10, has an acidic milieu.

The proton-conducting membrane 5 is a polymer electrolyte membrane made of a membrane material which has in particular a fluorinated polymer with sulfonic acid groups. The membrane 5 enables protons (H⁺) to be transported from the anode compartment 3 to the cathode compartment 4. The anode compartment 3 and the cathode compartment 4 are connected to an electrical consumer 11. The electrical consumer 11, for example, is an electric motor. In addition to the electrical consumer 11, an electrical storage unit, in particular a rechargeable battery, may be provided to temporarily store the electrical energy generated by the fuel cell 2. Electrons are conducted from the anode compartment 3 to the cathode compartment 4 via the electrical consumer 11.

An anode catalyst is provided in the anode compartment 3. The anode catalyst is a metal-containing electrocatalyst which has in particular platinum, ruthenium, palladium, iridium, gold, silver, rhenium, rhodium, copper, nickel, cobalt, iron, manganese, chromium, molybdenum and/or vanadium. The metals of the anode catalyst are present in particular as elemental metals, metal oxides and/or metal hydroxides. Mixed catalysts which have platinum and ruthenium, in particular in elemental form and/or in oxide form, have proven to be particularly advantageous.

A cathode catalyst is provided in the cathode compartment 4. The cathode catalyst used is a metal-containing electrocatalyst comprising platinum, ruthenium, palladium, iridium, gold, silver, rhenium, rhodium, copper, nickel, cobalt, iron, manganese, chromium, molybdenum and/or vanadium. The metals of the cathode catalyst are preferably present as elemental metals, as metal oxides and/or as metal hydroxides. Mixed catalysts which have the metals in elemental and/or oxide form have proven particularly suitable.

The cathode compartment 4 is connected to the reaction chamber 10 via a return line 12 for returning water. A storage container, not shown in more detail, can be provided along the return line 12 to store water temporarily.

According to the embodiment shown, the return line 12 opens into the feed line 7. Alternatively, it is possible that the return line 12 is designed separately from the feed line 7. In particular, it is conceivable that the return line 12 opens into the reaction chamber 10 at a separate return opening, i.e. independently of the feed line 7. As a result of the fact that the organic compound from the first storage container 6 and the water from the cathode compartment 4 are required for the same reaction in the reaction chamber 10, the organic compound and the water can be fed in and returned together via the feed line 7.

A water discharge line 22 is further provided on the cathode compartment 4. The water discharge line 22 serves to discharge excess water formed in the cathode compartment 4, which is not required in particular for the ether cleavage in the reaction chamber 10. The water discharged from the cathode compartment 4 can, for example, be supplied to the environment, in particular to a body of water, or stored in a water reservoir 23. Provided that the device 1 is integrated in a mobile application, the water from the cathode compartment 4 can be discharged to the environment via the water discharge line 22, in particular as water vapor.

An oxygen line 13 is connected to the cathode compartment 4. The oxygen line 13 serves to feed oxygen to the cathode compartment 4. The oxygen to be fed to the cathode compartment 4 can be fed to the cathode compartment 4 in particular in the form of ambient air.

In the following, a method for generating electric current is explained in more detail with reference to FIG. 1.

Diisopropyl ether is provided as an organic compound by storing diisopropyl ether in particular in the first storage container 6. The first storage container 6 can be fed in particular from a pipeline network, in particular a pipeline, or by means of a tanker or from a reservoir tank. The organic compound is fed to the reaction chamber 10 via the feed line 7.

Diisopropyl ether is fed in liquid form. Other organic compounds can be fed in liquid or gaseous form. The organic compound can be fed as a mixture with other liquids and/or gases or as a pure substance. In the case of liquid supply of the organic compound as a pure substance or as a mixture of the organic compound with another substance, the pressure in the anode compartment 3 of the fuel cell 2 can be between 0.1 bar and 10 bar, in particular between 1 bar and 5 bar and in particular between 1 bar and 3 bar.

Mixtures with water or water vapor, in particular with liquid or gaseous water, which has been generated in the cathode compartment 4 of the fuel cell 2 or an adjacent fuel cell 2, are particularly advantageous. An evaporation of the organic compound may take place in a bubble column, in particular filled with filling material, into which the water vapor formed in the cathode compartment 4 can be introduced. In this way, the enthalpy contained in the cathode gas can be transferred directly, i.e. immediately, to the organic compound. Heat losses are thus reduced and, in particular, avoided. In addition, periodic gas purging of the cathode gas, i.e. of the water vapor, can be provided to prevent an accumulation of nitrogen in the cathode gas.

It is advantageous that the reaction of the organic compound with water in the reaction chamber 10 to form the enriched hydrogen carrier medium can be carried out at temperature conditions which correspond to the temperature conditions of fuel cell operation.

The organic compound, the precursor and in particular the enriched hydrogen storage medium have a higher volumetric storage density than elemental hydrogen at ambient conditions. A major reason for this is the higher density of the organic compound, the precursor, and especially the enriched hydrogen storage medium. Typically, the density of the organic compound, the precursor and especially the enriched hydrogen storage medium is between 0.6 g/ml and 1.2 g/ml. The organic compound and/or precursor can be stored at room temperature and elevated pressure as a liquid with a very high density compared to liquid hydrogen. For example, diisopropyl ether as a liquid has a storage density of 0.73 g/ml at room temperature.

Liquid hydrogen has a storage density of only 0.07 g/ml at a temperature of −253° C.

The organic compound is reacted using water in the reaction chamber 10 to form an enriched hydrogen medium rich in hydrogen, i.e., in the case of diisopropyl ether as an organic compound, it is reacted to form isopropanol according to the following reaction equation by cleaving the ether function of diisopropyl ether with water:

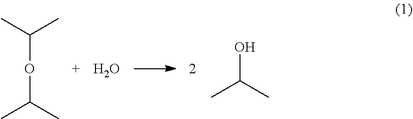

It is particularly advantageous that the enriched hydrogen carrier medium has at least one secondary alcohol group which can be converted into electricity in the fuel cell 2.

An essential aspect for the addition of water to the organic compound to form the enriched hydrogen carrier medium is the proton-containing acidic milieu provided in the reaction chamber 10 by the membrane material of the PEM membrane 5.

When the isopropanol is converted into electricity as an enriched hydrogen carrier medium, acetone and protons are formed in the anode compartment 3 of the fuel cell 2 according to the following reaction equation:

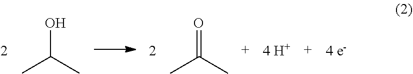

On the cathode catalyst, oxygen is reacted to form water in the cathode compartment 4 with the aid of the protons that have migrated through the membrane 5 and the necessary electrons according to the following equation:

O₂+4 H⁺+4 e⁻→2 H₂O (3)

During this process, an electrical potential is formed between the anode 14 and the cathode 15. The electrical potential can be tapped by means of the electrical consumer 11.

The water is returned to the anode compartment 3 via the return line 12. The oxygen fed via the oxygen line 13 or the air supplied therein is fed to the cathode compartment 4 at atmospheric pressure or at a slight overpressure of up to 10 bar.

The hydrogen carrier medium, the ketone, which is depleted during the conversion into electricity, is transported from the anode compartment 3 to the second storage container via the discharge line 8. According to the embodiment shown, the ketone is acetone. The depleted hydrogen carrier medium can be reacted again, in particular at a high-energy time and/or at a high-energy location, by hydrogenation and dehydrogenation to form an organic compound which can be used again for the generation of electric current in the method according to the invention.

A significant advantage of the method is the increased usable energy density of the organic compound, for example, compared to secondary alcohols having the same number of carbon atoms, which lead to the same organic product in a conversion process into electricity through the fuel cell. The increased energy density can be explained using the example of the conversion of isopropanol, which is also referred to as 2-propanol in the technical literature, into electricity. Isopropanol has a mass of 60.10 g/mol. When isopropanol is converted into electricity, one hydrogen molecule per one 2-propanol molecule can be converted into electricity in the fuel cell. Acetone is formed as a reaction product. Consequently, the usable mass of hydrogen in 2-propanol is 2 g/mol. Consequently, the hydrogen capacity of 2-propanol in this application is 3.3 mass % or 1.11 kWh per kg of 2-propanol. In the use of diisopropyl ether as an organic compound according to the invention, one mole of diisopropyl ether is first converted to two moles of 2-propanol with the aid of water. The usable hydrogen mass in the fuel cell 2 is 4 g/mol. Diisopropyl ether has a molecular weight of 102.18 g/mol, so the hydrogen capacity of diisopropyl ether is 3.92 mass % or 1.30 kWh per kg of diisopropyl ether. The device 1 operated with diisopropyl ether instead of 2-propanol has a 19% greater range for the same mass of organic compound. The device 1 is particularly advantageous for mobile applications, in particular in vehicles and/or aircraft.

The device 1 according to FIG. 1 can also be operated with other organic compounds.

Diisopropyl ether is a liquid boiling at 68° C., whereas the boiling point of 2-propanol is 82° C. The higher volatility of the organic fuel diisopropyl ether facilitates the gaseous penetration of the organic fuel into the fuel cell 2 and avoids the condensation of the organic fuel in the fuel cell 2 under the conditions of fuel cell operation.

Alternatively, 2,5-dimethylfuran, a liquid that boils at 94° C. and has a melting point of −62° C., may serve as an organic compound. The compound has two double bonds which form an aromatic system with a ring oxygen. 2,5-Dimethylfuran has a molar mass of 96.13 g/mol. The reaction of the organic compound with up to two moles of water produces a compound or a corresponding mixture and compounds having up to two secondary alcohol functions, which are converted into electricity at the PEM fuel cell 2. In the process, the up to two secondary alcohol functions are transformed into up to two keto functions.

The usable hydrogen mass of 2,5-dimethylfuran is therefore 4 g/mol with a molecular weight of 96.13 g/mol. The hydrogen capacity is thus 4.16 mass % or 1.38 kWh per kg of 2,5-dimethylfuran.

Surprisingly, it has been found that the hydrogen capacity of 2,5-dimethylfuran is enhanced by reacting the two double bonds of the molecule with water, thereby forming two secondary alcohol functions. All the alcohol functions formed can be converted into electricity to form keto functions at the PEM membrane.

The cleavage of the ether function can be performed before, during or after the hydrogenation of the double bonds of the molecule.

The total hydrogen capacity of 2,5-dimethylfuran is thus increased to 8 g/mol with a molecular weight of 96.13 g/mol. The hydrogen capacity in this method variant is 8.32 mass % or 2.77 kWh per kg of 2,5-dimethylfuran. A vehicle running on 2,5-dimethylfuran instead of isopropanol would therefore have a 250% greater range for the same fuel mass.

2,5-Dimethylfuran is an advantageous organic compound also due to the fact that it is straightforwardly accessible from sugars and biogenic feedstocks. 2,5-Dimethylfuran can be obtained directly from biomass. This organic compound can be sustainably provided for carrying out the method.

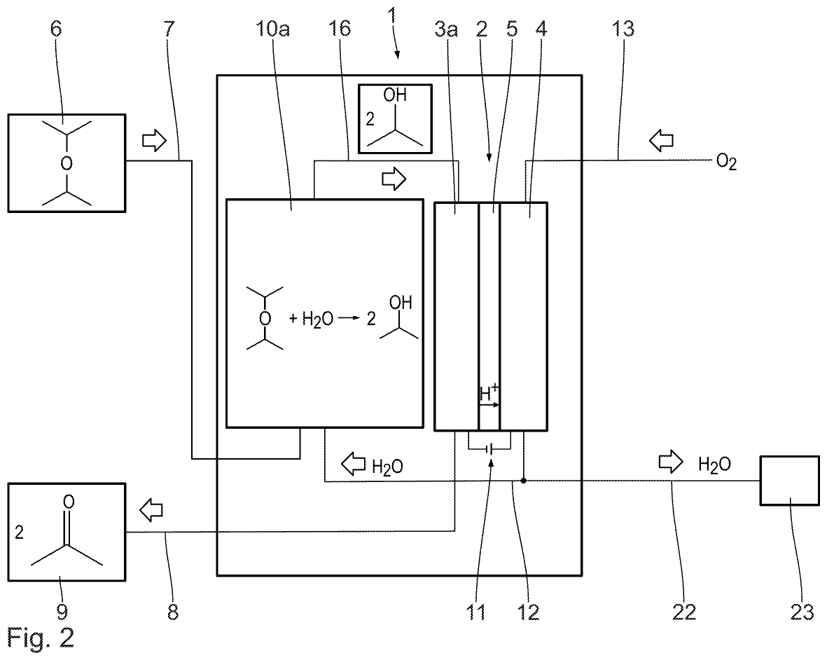

A second embodiment of the invention is described below with reference to FIG. 2. Constructively identical parts are given the same reference signs as in the first embodiment. Constructively different, but functionally similar parts are given the same reference signs with an a after them.

A significant difference compared to the first embodiment is that the reaction chamber 10a is designed separately from the anode compartment 3a. The reaction chamber 10a is directly connected to the anode compartment 3a of the fuel cell 2 via a fluid line 16. The reaction chamber 10a is arranged in the immediate vicinity of the anode compartment 3a.

According to the embodiment shown, the reaction chamber 10a is designed as a reaction apparatus which is arranged upstream of the fuel cell, in particular the anode compartment 3a. In order to favor the conversion of diisopropyl ether into isopropanol in the reaction chamber 10a, an acidic catalyst is provided in the reaction chamber 10a. The acidic catalyst generates the acidic environment required for the conversion.

Accordingly, the cathode compartment 4 is connected to the reaction chamber 10a via the return line 12.

In the following, the function of the device according to the second embodiment is explained in more detail.

With regard to the individual process steps, reference is made to the explanations regarding the first embodiment. According to the embodiment shown, the organic compound used is diisopropyl ether, which is fed from the first storage container 6 via the feed line 7 into the reaction chamber 10a. In the reaction chamber 10a, the conversion of the diisopropyl ether into isopropanol takes place. The isopropanol thus formed is transferred from the reaction chamber 10a to the anode compartment 3a via the fluid line 16. In the fuel cell 2, the conversion of the isopropanol into electricity takes place by forming acetone in the anode compartment 3a and water in the cathode compartment 4.

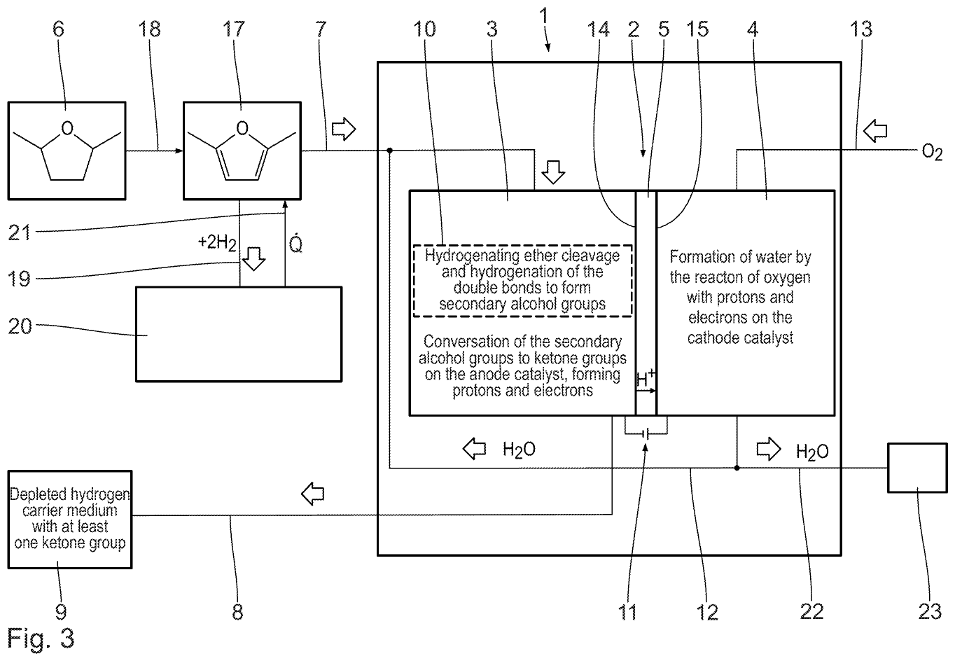

A third embodiment is described below with reference to FIG. 3. Constructively identical parts are given the same reference signs as in the first embodiment.

An essential difference of the device according to the third embodiment is that a dehydrogenation reactor 17 is arranged upstream of the reaction chamber 10. The dehydrogenation reactor 17 is connected to the first storage container 6 via a fluid line 18. The dehydrogenation reactor 17 is connected to the reaction chamber 10 in the anode compartment 3 via the feed line 7.

The dehydrogenation reactor 17 is connected to a second fuel cell 20 via a hydrogen gas line 19. The second fuel cell 20 and the hydrogen gas line 19 can also be omitted.

In all other respects, the device according to FIG. 3 corresponds to the device according to FIG. 1.

A method for generating electric current according to the device in FIG. 3 is explained in more detail below.

An essential difference compared to the method explained with reference to FIG. 1 is that a precursor, according to the embodiment shown 2,5-dimethyltetrahydrofuran, is stored in the first storage container 6.

2,5-Dimethyltetrahydrofuran is fed from the first storage container 6 via the fluid line 18 to the dehydrogenation reactor 17, where it is catalytically dehydrogenated. As a result of the dehydrogenation reaction, hydrogen gas is released and 2,5-dimethylfuran is formed. The released hydrogen gas can be fed to the second fuel cell 20 via the hydrogen gas line 19, where it can be converted into electricity. Additionally or alternatively, the hydrogen gas can be fed to the anode compartment 3 of the fuel cell 2 via the feed line 7 and converted into electricity there. The use of the second fuel cell 20 is not mandatory, but can be advantageous for increasing efficiency.

2,5-Dimethyltetrahydrofuran at normal conditions is a liquid having a density of 0.83 g/ml and a boiling point of 92° C. The compound can be dehydrogenated at a temperature above 100° C. over a platinum-containing catalyst to form 2,5-dimethylfuran and hydrogen gas, wherein the equilibrium position of the dehydrogenation reaction is increasingly on the side of 2,5-dimethylfuran and hydrogen gas as the temperature increases.

2,5-Dimethylfuran is fed from the dehydrogenation reactor 17 via the feed line 7 to the anode compartment 3 of the fuel cell 2, in particular to the reaction chamber 10. In reaction chamber 10, hydrogenating ether cleavage and hydrogenation of the double bonds to form secondary alcohol groups takes place. In the anode compartment 3, the conversion of the secondary alcohol groups to ketone groups takes place on the anode catalyst, forming protons and electrons.

In the cathode compartment 4, the formation of water takes place by the reaction of oxygen with protons and electrons on the cathode catalyst.

The depleted hydrogen carrier medium having at least one ketone group is discharged from the anode compartment 3 via the discharge line 8 and stored in the second storage container 9.

The required dehydrogenation heat may be provided by the heat flow 21 from the second fuel cell 20. The second fuel cell 20 may be provided as a solid oxide fuel cell or in the form of another type of fuel cell, wherein the released hydrogen gas is converted into electricity in the fuel cell and waste heat is generated at a temperature level above 120° C. in sufficient quantity. Alternatively, the heat required for the dehydrogenation of 2,5-dimethyltetrhydrofuran to 2,5-dimethylfuran can also be provided by burning a portion of the released hydrogen in a hydrogen burner. With regard to the further use of 2,5-dimethylfuran, reference is made to the embodiment described above.

The total amount of usable hydrogen is up to 12 g per mole of 2,5-dimethyltetrahydrofuran with a molecular weight of 100.16 g/mol. Accordingly, the hydrogen capacity of 2,5-dimethyltetrahydrofuran is up to 11.98 mass % or 3.99 kWh per kg of 2,5-dimethyltetrahydrofuran in a multiple use of dehydrogenation, hydrogenation and subsequent isoalcohol conversion into electricity. A vehicle running on 2,5-dimethyltetrahydrofuran instead of isopropanol has a 359% greater range for the same fuel mass.

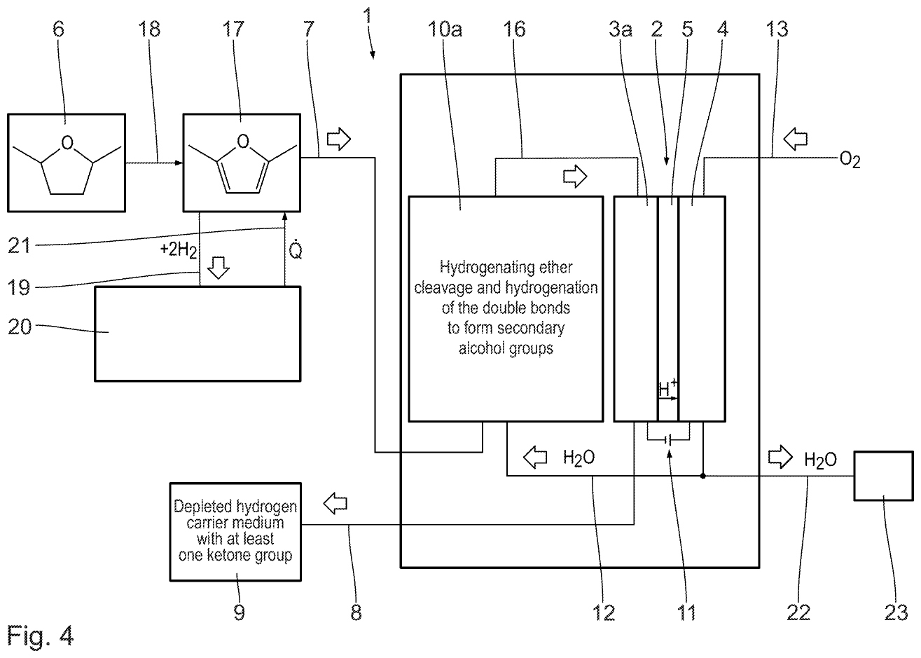

A fourth embodiment of the invention is described below with reference to FIG. 4. Constructively identical parts are given the same reference signs as in the previous embodiments.

The device 1 according to FIG. 4 essentially corresponds to a combination of the devices according to FIGS. 2 and 3. The device 1 according to FIG. 4 has the upstream dehydrogenation reactor 17, which is connected to the second fuel cell 20 via the hydrogen gas line 19.

Since the reaction chamber 10a is designed separately from the anode compartment 3a, the dehydrogenation reactor 17 is connected to the reaction chamber 10a via the feed line 7.

As explained with reference to the embodiment illustrated in FIG. 3, in the dehydrogenation reactor 17, the precursor 2,5-dimethyltetrahydrofuran is first dehydrogenated to 2,5-dimethylfuran, wherein the released hydrogen gas can be converted into electricity in the fuel cell 2 and/or in the second fuel cell 20. 2,5-Dimethylfuran is fed as an organic compound into the reaction chamber 10a, where it is converted by hydrogenation and hydrogenating ether cleavage into compounds having secondary alcohol functions, which are converted into electricity in the fuel cell 2.

With regard to the further mode of operation, i.e. the implementation of a method for generating electric current with the device according to FIG. 4, reference is made to the above embodiments.

1. A method for generating electric current, the method comprising the steps of
providing an organic compound having at least one ether function,
reacting the organic compound with water in a reaction chamber having an acidic environment to form an enriched hydrogen carrier medium,
converting the enriched hydrogen carrier medium into electricity to form a depleted hydrogen carrier medium in a fuel cell, obtaining water, and
providing electric current generated during said conversion into electricity.

2. The method according to claim 1, wherein the water from the fuel cell generated during the conversion into electricity is returned at least proportionally to the reaction chamber for the reaction of the organic compound.

3. The method according to claim 1, wherein the hydrogen capacity of the organic compound is greater than the hydrogen capacity of the enriched hydrogen carrier medium, wherein the hydrogen capacity of the organic compound is at least 1.05 times the hydrogen capacity of the enriched hydrogen carrier medium.

4. The method according to claim 1 wherein the organic compound is diisoalkyl ether.

5. The method according to claim 1 wherein at least one of a membrane of the fuel cell and a separate acidic catalyst serves as acidic medium for generating the acidic environment required for the reaction of the organic compound.

6. The method according to claim 1 wherein the organic compound is provided by dehydrogenation of a precursor.

7. A device for generating electric current, comprising
a. a reaction chamber having an acidic milieu in which an organic compound can be reacted with water to form an enriched hydrogen carrier medium, and
b. a fuel cell having an anode compartment, a proton-conducting membrane, and a cathode compartment for converting the enriched hydrogen carrier medium into electricity to form a depleted hydrogen carrier medium,
wherein the reaction chamber is connected to the anode compartment for delivering the enriched hydrogen carrier medium.

8. The device according to claim 7, wherein the reaction chamber is integrated in the anode compartment of the fuel cell.

9. The device according to claim 7, wherein the reaction chamber is connected to the anode compartment via a fluid line.

10. The device according to any one of claims 7, wherein the cathode compartment is connected to the reaction chamber via a return line for the return of water.

11. The device according to claim 7, further comprising a second fuel cell for the conversion into electricity of hydrogen gas from the organic compound.

12. A process comprising generating electric current with an organic compound, wherein the organic compound has at least one ether function.

13. The process according to claim 12, wherein the generation of current takes place in a mobile application.

14. The process according to claim 12, wherein the organic compound is one of diisopropyl ether, diisobutyl ether, diisopentyl ether, 2,5-dimethylfuran, 2,6-dimethylpyran, mono-isopropyl ether of secondary alcohols, of secondary diols, of secondary triols and/or of carbohydrate compounds having exclusively secondary alcohol functions, di-isopropyl ether of secondary diols, of secondary triols and/or of carbohydrate compounds having exclusively secondary alcohol functions, tri-isopropyl ethers of secondary triols and/or of carbohydrate compounds having exclusively secondary alcohol functions, oligo-isobutyl ethers having more than three isopropyl groups of carbohydrate compounds having exclusively secondary alcohol functions, mono-isobutyl ethers of secondary alcohols, of secondary diols, of secondary triols and/or of carbohydrate compounds having exclusively secondary alcohol functions, di-isobutyl ethers of secondary diols, secondary triols and/or of carbohydrate compounds having exclusively secondary alcohol functions, tri-isobutyl ethers of secondary triols and/or of carbohydrate compounds having exclusively secondary alcohol functions, olio-isobutyl ethers having more than three isopropyl groups of carbohydrate compounds having exclusively secondary alcohol functions, cyclic ethers having one of one and more oxygen atoms, during the hydrolytic cleavage of which exclusively secondary alcohol functions are formed, and a mixture of at least two of the above-mentioned compounds.

15. The method according to claim 1, wherein the water from the fuel cell generated during the conversion into electricity is returned completely to the reaction chamber for the reaction of the organic compound

16. The method according to claim 1, wherein the organic compound is one of diisopropyl ether, diisobutyl ether, diisopentyl ether, 2,5-dimethylfuran, 2,6-dimethylpyran, mono-isopropyl ether of secondary alcohols, of secondary diols, of secondary triols and/or of carbohydrate compounds having exclusively secondary alcohol functions, di-isopropyl ethers of secondary diols, of secondary triols and/or of carbohydrate compounds having exclusively secondary alcohol functions, tri-isopropyl ethers of secondary triols and/or of carbohydrate compounds having exclusively secondary alcohol functions, oligo-isobutyl ethers having more than three isopropyl groups of carbohydrate compounds having exclusively secondary alcohol functions, mono-isobutyl ethers of secondary alcohols, of secondary diols, of secondary triols and/or of carbohydrate compounds having exclusively secondary alcohol functions, di-isobutyl ethers of secondary diols, secondary triols and/or of carbohydrate compounds having exclusively secondary alcohol functions, tri-isobutyl ethers of secondary triols and/or of carbohydrate compounds having exclusively secondary alcohol functions, olio-isobutyl ethers having more than three isopropyl groups of carbohydrate compounds having exclusively secondary alcohol functions, cyclic ethers having one of one and more oxygen atoms, during the hydrolytic cleavage of which exclusively secondary alcohol functions are formed, and a mixture of at least two of the above-mentioned compounds.

17. The device according to claim 7, wherein the proton-conducting membrane has a material that generates the acidic milieu.

18. The device according to claim 7, wherein in the reaction chamber an acidic catalyst is provided.
